(19) United States
(12) Patent Application Publication
(10) Pub. No.: US 2008/0028017 A1
(43) Pub. Date: Jan. 31, 2008

(54) SYSTEM AND METHOD FOR DISTRIBUTING EMAIL ATTACHMENTS

(76) Inventors: Zachary A. Garbow, Rochester, MN (US); Michael W. Sharek, Edmonton (CA)

Correspondence Address: HOFFMAN, WARNICK & D'ALESSANDRO LLC, 75 STATE ST, 14TH FLOOR, ALBANY, NY, 12207, US

(21) Appl. No.: 11/684,777

(22) Filed: Mar. 12, 2007

(30) Foreign Application Priority Data
Jul. 28, 2006 (CA) 2554991

(51) Int. Cl. G06F 15/16

(52) U.S. Cl. 709/201

(57) ABSTRACT

A system and method for distributing email attachments. In an embodiment, a peer-to-peer network is used to distribute attachments among email recipients. A metadata file is generated and sent to a central tracking server (e.g., on the sender's local email server). The central tracking server may maintain an access control list, track mail recipients, track peers sharing the file attachment, and track which pieces of the attachment that each peer has. In lieu of the file attachment, each recipient of the email may receive a token or stub representing the file attachment. The stub may contain metadata about the file attachment with information for querying the central tracking server. A file download request may be initiated by a recipient via the stub. The recipient's local email client may query the central tracking server to obtain authorized access to a peer-to-peer network to download the file attachment. Only authorized recipients on the access control list are permitted to download the file via the peer-to-peer network.

### COPYRIGHT NOTICE

A portion of the disclosure of this patent document contains material which is subject to copyright protection. The copyright owner has no objection to the facsimile reproduction of the patent document or the patent disclosure, as it appears in the United States Patent and Trademark Office patent file or records, but otherwise reserves all copyright rights whatsoever.

### BACKGROUND OF THE INVENTION

The present invention relates to systems and methods for distributing email attachments.

Email is an indispensable tool for business communications today. However, it has some limitations. For example, an email that includes an attachment may be sent to numerous recipients. However, when a large attachment is sent via email to multiple recipients, it may have some negative consequences. For example, every recipient may receive the attachment whether or not the email is relevant to them. Further, every recipient's mailbox may store a redundant copy of the attachment which consumes valuable space on the recipients' email server(s). Also, a copy of the attachment may be sent over the network to every recipient, and the recipient may have to wait to receive the entire file. Many email servers may also limit the size of an email attachment, typically to a few megabytes or less, so some larger attachments may not be sent at all. What is needed is a method and system for distributing email attachments that may overcome these and other limitations of the prior art.

### SUMMARY OF THE INVENTION

The present invention relates to a system and method for distributing email attachments.

In an embodiment, a peer-to-peer network is used to distribute attachments among email recipients. A metadata file is generated and sent to a central tracking server, as provided, for example, on the sender's local email server. The central tracking server may maintain an access control list, track mail recipients, track peers sharing the file attachment, and track which pieces of the attachment that each peer has. In lieu of the file attachment, each recipient of the email may receive a token or stub representing the file attachment. The stub may contain metadata about the file attachment with information for querying the central tracking server. A file download request may be initiated by a recipient via the stub. The recipient's local email client may query the central tracking server to obtain authorized access to a peer-to-peer network to download the file attachment. Distribution of the file attachment via email may be controlled by controlling the addition of recipients to the access control list. Only authorized recipients on the access control list are permitted to download the file via the peer-to-peer network.

In an aspect of the invention, there is provided a method of distributing an email file attachment to recipients, comprising: generating a metadata file associated with the file attachment and sending the metadata file to authorized recipients in lieu of the file attachment; storing a copy of the file attachment on a network server accessible via a peer-to-peer network; generating an access control list corresponding to authorized recipients of the file attachment; and utilizing the access control list to control access to the file attachment via the peer-to-peer network.

In an embodiment, the method further comprises utilizing a peer participant tracking module to track peers receiving the file attachment or pieces thereof.

In another embodiment, the method further comprises tracking information concerning which pieces of the file attachment each peer has.

In another embodiment, the method further comprises providing access to the tracking information to each authorized recipient's email client so as to permit them to share pieces of the file attachment.

In yet another embodiment, the method further comprises controlling any further access to the file attachment by other recipients of the metadata file by controlling the addition of authorized recipients to the access control list.

In another embodiment, the method further comprises presenting the metadata file in the form of a token or stub attached to the email.

In another embodiment, the method further comprises configuring the token or stub to be selectable to initiate a request to access the file attachment via the peer-to-peer network.

In another aspect of the invention, there is provided a system for distributing an email file attachment to recipients, comprising: a system for generating a metadata file associated with the file attachment and sending the metadata file to authorized recipients in lieu of the file attachment; a network server for storing a copy of the file attachment, the network server being accessible via a peer-to-peer network; an access control list corresponding to authorized recipients of the file attachment; and a system for utilizing the access control list to control access to the file attachment via the peer-to-peer network.

In an embodiment, the system further comprises a peer participant tracking module for tracking peers receiving the file attachment or pieces thereof.

In another embodiment, the system further comprises a system for tracking information concerning which pieces of the file attachment each peer has.

In another embodiment, the system further comprises a system for providing access to the tracking information to each authorized recipient's email client so as to permit them to share the pieces of the file attachment.

In another embodiment, the system further comprises a system for controlling the addition of authorized recipients to the access control list, thereby controlling any further access to the file attachment via the peer-to-peer network.

In another embodiment, the system further comprises a system for presenting the metadata file in the form of a token or stub attached to the email.

In yet another embodiment, the token or stub is selectable to initiate a request to access the file attachment via the peer-to-peer network.

In another aspect of the invention, there is provided a program product stored on a computer readable medium, which when executed, distributes an email file attachment, the computer readable medium comprising program code for: generating a metadata file associated with the file attachment and sending the metadata file to authorized recipients in lieu of the file attachment; storing a copy of the file attachment on a network server accessible via a peer-to-peer network; generating an access control list corresponding to authorized recipients of the file attachment; and utilizing the access control list to control access to the file attachment via the peer-to-peer network.

In an embodiment, the computer readable medium further comprises program code for utilizing a peer participant tracking module to track peers receiving the file attachment or pieces thereof.

In another embodiment, the computer readable medium further comprises program code for tracking information concerning which pieces of the file attachment each peer has.

In another embodiment, the computer readable medium further comprises program code for providing access to the tracking information to each authorized recipient's email client so as to permit them to share pieces of the file attachment.

In another embodiment, the computer readable medium further comprises program code for controlling any further access to the file attachment by other recipients of the metadata file by controlling the addition of authorized recipients to the access control list.

In another embodiment, the computer readable medium further comprises program code for presenting the metadata file in the form of a token or stub attached to the email.

In another embodiment, the computer readable medium further comprises program code for configuring the token or stub to be selectable to initiate a request to access the file attachment via the peer-to-peer network.

These and other aspects of the invention will become apparent from the following more particular descriptions of exemplary embodiments.

### BRIEF DESCRIPTION OF THE DRAWINGS

These and other features of this invention will be more readily understood from the following detailed description of the various aspects of the invention taken in conjunction with the accompanying drawings.

FIG. 1 depicts a generic data processing system that may provide a suitable operating environment.

FIG. 2 depicts a schematic block diagram of illustrative email servers and email clients connected via a network.

FIG. 3 depicts a schematic block diagram of one of the email servers of FIG. 2.

FIG. 4 depicts a schematic flow chart of an illustrative method in accordance with an embodiment of the present invention.

### DETAILED DESCRIPTION OF THE INVENTION

As noted above, the present invention relates to a system and method for distributing email attachments.

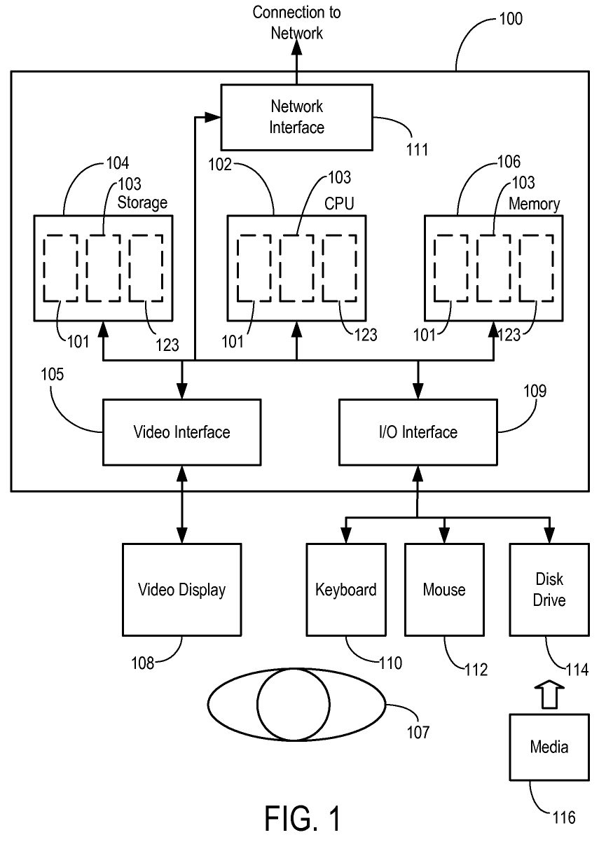

The invention may be practiced in various embodiments. A suitably configured data processing system, and associated communications networks, devices, software and firmware, may provide a platform for enabling one or more of these systems and methods. By way of example, FIG. 1 shows a generic data processing system 100 that may include a central processing unit (CPU) 102 connected to a storage unit 104 and to a random access memory (RAM) 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In a known manner, the mouse 112 may be configured to control movement of a cursor in the video display 108, and to operate various graphical user interface (GUI) controls appearing in the video display 108 with a mouse button. The disk drive 114 may be configured to accept computer readable media 116, which is readable by the data processing system 100. The data processing system 100 may form part of a network via a network interface 111, allowing the data processing system 100 to communicate with other suitably configured data processing systems (not shown). The particular configurations shown by way of example in this specification are not meant to be limiting.

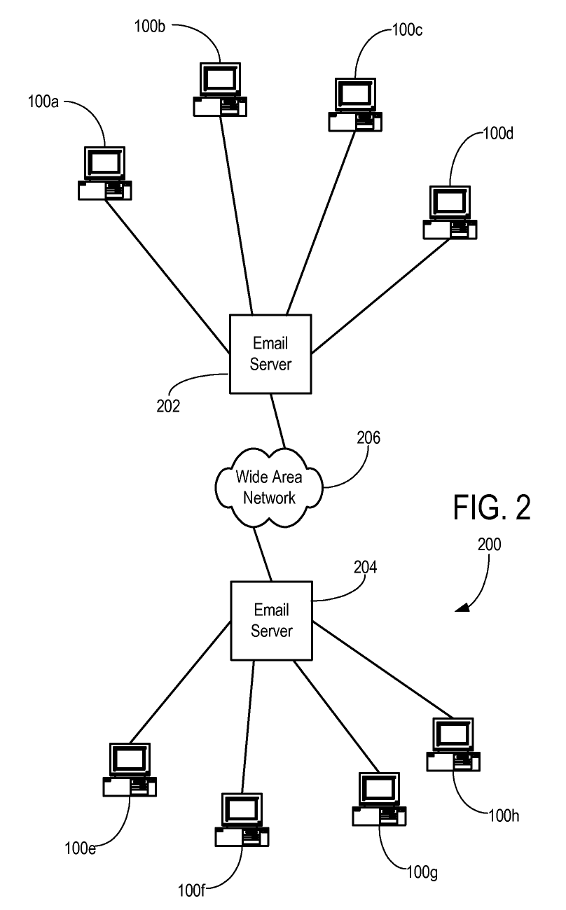

Now referring to FIG. 2, shown is a schematic block diagram 200 of email servers 202, 204 connecting via a network 206 various email clients at data processors 100a to 100h. It will be appreciated that email client in this context may refer to the software module residing on the data processors 100a to 100h to handle various email tasks. In this illustrative example, email server 202 may serve email users at data processors 100a to 100d connected to a local area network (LAN), and email server 204 may serve email users at data processors 100e to 100h connected to another LAN via a wide area network (WAN) connection. The email network of FIG. 2 may also connect email users with wireless communications devices (not shown).

In this illustrative example, an email user at any one of data processors 100a to 100h may send an email and a file attachment to one or more email recipients at any one of data processors 100a to 100h. As noted above, existing approaches to distributing email file attachments may have some limitations. In order to address some of these limitations, the inventors propose the use of peer-to-peer or P2P file sharing technology for the distribution of email file attachments.

P2P and related technologies have been in use for a number of years for file sharing between computer users, with some relating to emails. For example, EpostMail™ at URL www.epostmail.org is a “cooperative, serverless email system” that uses P2P technology to provide email infrastructure. However, EpostMail simply allows users to email each other without going through a central email server and does not provide a distributed attachment downloading system and method. Peer2Mail™ at URL www.peer2mail.com is another example of a P2P application that allows large files to be stored on email servers by creating emails with attachments and sending them to the email server. This basically turns an email user's account into a file system by storing large files as smaller parts within the user's email. However, Peer2Mail does not provide a system and method for distributed attachment downloading among multiple email recipients, nor does it provide the security options that are proposed herein.

There are other examples of P2P networks, protocols and applications. However, these networks, protocols or applications do not integrate with an email client or email server to provide the system and method in accordance with various embodiments of the present invention. An illustrative embodiment will now be described.

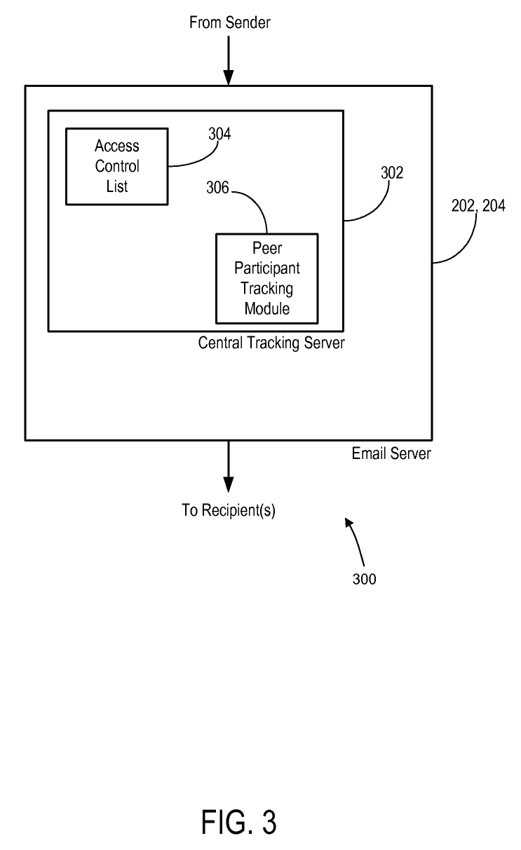

Referring to FIG. 3, shown is a schematic block diagram 300 of one of the email servers 202, 204 of FIG. 2. As shown, the email server 202, 204 may include a central tracking server 302 that may control various file attachment distribution functions including access control and tracking peer participants. In an embodiment, the central tracking server 302 may be configured to store an access control list 304 for authorizing recipients and a peer participant tracking module 306 for tracking peer participants in the P2P network.

As an illustrative example, an email user A (e.g., a user of data processor 100a, FIG. 2) may compose an e-mail with a file attachment and address the email to users B, C, D and E (e.g., users of data processors 100e to 100h). User A's email client on data processor 100a sends the email and entire file attachment to a network server accessible via a P2P network (e.g., email server 202) along with a metadata file associated with the file attachment and containing location information about the file attachment. This information may be, for example, the location of the central tracking server 302 controlling access to the file attachment. In an embodiment, the metadata may be in the form of a token or stub.

Using conventional email delivery, the email message itself may be delivered to the mailboxes of users B, C, D, E. However, in lieu of the file attachment, the email may simply include the stub. Upon receiving the email, user B may open it and decide that he is not interested in the attachment. User B therefore may make no request to download the file attachment and the file attachment is not sent to user B. On the other hand, users C and D open the email message and may decide to view the attachment. Their respective email clients on their respective data processors may process the metadata information in the stub that was sent to them in the email, and use it to access the central tracking server 302 for authorized access to the file attachment via the P2P network. An illustrative example of a P2P network protocol that may be used is BitTorrent™. BitTorrent file sharing applications may be used to distribute large files among multiple users by splitting the files into pieces and sending/receiving these pieces into whole files to users who request it.

The central tracking server 302 that is tracking authorized download recipients may allow the recipients to join the P2P network if they appear as authorized recipients of the message from user A in the access control list 304. Users C and D can then download the file as members of a P2P network composed of users A, C, D and the email server 202.

In an embodiment, if user E forwards the email message to user F, and user F is added as an authorized recipient to access control list 304, then user F may be allowed to download the file attachment by joining the same P2P network. (In order to verify who is requesting the file attachment download, email encryption and authentication certificates may be used by the central tracking system 304.) However, if user G contacts the email server and attempts to download the file, this request may be denied since user G was not a recipient of the original message from user A or any subsequent message. This security feature implemented by the access control list 304 prevents unauthorized users from downloading and viewing the file attachments via the P2P network.

In an embodiment, rather than using solely the sender's email server to distribute a large attachment to multiple users, email users may work within the P2P network to achieve the same result while minimizing the negative effects of distributing large files. This approach may reduce network load on a single server, reduce storage space taken up by the email attachments, and increase the speed in which a file attachment is received. As well, email attachments are delivered only to those recipients who are interested in accessing the attachment, and the email server needs to retain only one copy of the attachment, potentially saving significant storage space on the email server.

In an embodiment, the file attachment download may be automatic or manually initiated. For example, recipients listed in the “To:” lines of an email may automatically have the file attachment downloaded via P2P without needing to request the download, while those on the “CC:” (carbon copy) or “BCC:” (blind carbon copy) lines may need to request download. These download options may be configurable by the sender and/or the recipient as may be appropriate.

In an embodiment, rather than being active all the time, the email attachment distribution system of the present invention may be engaged when a file attachment over a particular size threshold is addressed to be sent to multiple email recipients. A suitable size threshold may be configured by the user or system administrator and adjusted as may be necessary. The system may also be engaged manually by the sender.

With the foregoing description of an illustrative system, a corresponding method in accordance with an embodiment will now be described.

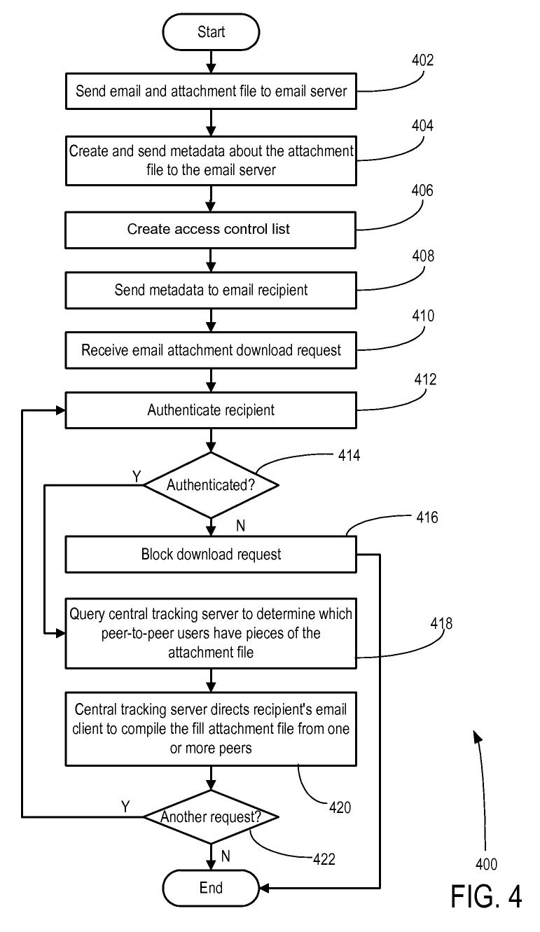

Referring to FIG. 4, at block 402, method 400 may prompt the sender's email client to send the email and entire file attachment (i.e., the seed file) to a network server accessible via a P2P network. For example, this network server may be the sender's email server.

At block 404, method 400 may prompt a metadata file containing information about the file attachment to be generated and sent to the sender's email server.

At block 406, an access control list (e.g., access control list 304, FIG. 3) may be created corresponding to the email recipient list and stored on a central tracking server (e.g., central tracking server 302). This central tracking server may also track which peers are participating in the P2P network and sharing the file (e.g., using a peer participant tracking module 306).

At block 408, each authorized email attachment recipient may be sent a stub (i.e., the metadata file) within their email in lieu of the file attachment.

At block 410, method 400 may wait to receive a file download request from a recipient that has selected or clicked on the stub.

At block 412, the central tracking server may be queried to authenticate the requester's identity by reviewing the access control list.

At decision block 414, if authentication is unsuccessful, then at block 416 the download request is denied and method 400 ends. If authentication is successful, then at block 418 the recipient's email client may query the peer participant tracking module to determine which peers are participating and which have pieces of the file attachment.

At block 420, the recipient's email client may request pieces of the file attachment from the different users as directed by the central tracking server and may compile the entire file attachment from the individual pieces.

At decision block 422, method 400 determines if there is another download request. If yes, method 400 may return to block 412 and repeat. The email attachment can then be downloaded from those recipients who already have it, as tracked by the central tracking server. If no, method 400 ends.

As noted earlier, the present invention proposes a security mechanism for distribution of email attachments. In common P2P networks, a shared file can usually be downloaded by any client that obtains the metadata file associated with the shared file. In order to avoid unauthorized access, the solution proposed by the inventors allows only those people who are listed as authorized recipients in an access control list to download the file. For example, if a recipient forwards the email attachment to another user, the new user may be added as a new authorized recipient in the access control list. In this case, the metadata file will be sent to the new recipient, and the new recipient may also be authorized to receive the shared file attachment.

In an alternative embodiment, the ability for the initial recipients of an email to forward the email attachment to another user may be restricted by the sender via the central tracking server. This may be done, for example, by configuring the central tracking server to not allow any further recipients to be added to the access control list corresponding to the file attachment. In this alternative embodiment, even if the stub is forwarded to another user, if the user is not added as a recipient in the access control list, that user would not be authorized by the central tracking server to access the P2P network to gain access to the file attachment. Rather, a user would have to take some positive step to forward the attachment to the unauthorized recipient in some other manner.

In another embodiment, when an attachment is received for sharing, it can also be sent to other servers which can act as peer proxies for the P2P downloading. This may provide greater availability while still spreading the initial load to multiple servers. If the tracking server is integrated with an instant messaging server, it can check the online presence of the recipients, and based on this can decide the best way to share the file—either through email client peers or other server peers.

As well, it will be appreciated that the system and method of the present invention effectively removes restrictive limits to the size of file attachments, and may distribute the network bandwidth demands more efficiently. The speed of delivery of attachments may also be increased.

While various illustrative embodiments of the invention have been described above, it will be appreciated by those skilled in the art that variations and modifications may be made. Thus, the scope of the invention is defined by the following claims.

1. A method of distributing an email file attachment to recipients, comprising:
generating a metadata file associated with the file attachment and sending the metadata file to authorized recipients in lieu of the file attachment;
storing a copy of the file attachment on a network server accessible via a peer-to-peer network;
generating an access control list corresponding to authorized recipients of the file attachment; and
utilizing the access control list to control access to the file attachment via the peer-to-peer network.

2. The method of claim 1, further comprising:
utilizing a peer participant tracking module to track peers receiving the file attachment or pieces thereof.

3. The method of claim 2, further comprising:
tracking information concerning which pieces of the file attachment each peer has.

4. The method of claim 3, further comprising:
providing access to the tracking information to each authorized recipient's email client so as to permit each authorized recipient's email client to share pieces of the file attachment.

5. The method of claim 1, further comprising:
controlling any further access to the file attachment by other recipients of the metadata file by controlling addition of authorized recipients to the access control list.

6. The method of claim 1, further comprising:
presenting the metadata file in the form of a token or stub attached to the email.

7. The method of claim 6, further comprising:
configuring the token or stub to be selectable to initiate a request to access the file attachment via the peer-to-peer network.

8. A system for distributing an email file attachment to recipients, comprising:
a system for generating a metadata file associated with the file attachment and sending the metadata file to authorized recipients in lieu of the file attachment;
a network server for storing a copy of the file attachment, the network server being accessible via a peer-to-peer network;
an access control list corresponding to authorized recipients of the file attachment; and
a system for utilizing the access control list to control access to the file attachment via the peer-to-peer network.

9. The system of claim 8, further comprising:
a peer participant tracking module for tracking peers receiving the file attachment or pieces thereof.

10. The system of claim 9, further comprising:
a system for tracking information concerning which pieces of the file attachment each peer has.

11. The system of claim 10, further comprising:
a system for providing access to the tracking information to each authorized recipient's email client so as to permit each authorized recipient's email client to share the pieces of the file attachment.

12. The system of claim 8, further comprising
a system for controlling addition of authorized recipients to the access control list, thereby controlling any further access to the file attachment via the peer-to-peer network.

13. The system of claim 8, further comprising
a system for presenting the metadata file in the form of a token or stub attached to the email.

14. The system of claim 13, wherein the token or stub is selectable to initiate a request to access the file attachment via the peer-to-peer network.

15. A program product stored on a computer readable medium, which when executed, distributes an email file attachment, the computer readable medium comprising program code for:
generating a metadata file associated with the file attachment and sending the metadata file to authorized recipients in lieu of the file attachment;
storing a copy of the file attachment on a network server accessible via a peer-to-peer network;
generating an access control list corresponding to authorized recipients of the file attachment; and
utilizing the access control list to control access to the file attachment via the peer-to-peer network.

16. The computer readable medium of claim 15, further comprising program code for:
utilizing a peer participant tracking module to track peers receiving the file attachment or pieces thereof.

17. The computer readable medium of claim 16, further comprising program code for:
tracking information concerning which pieces of the file attachment each peer has.

18. The computer readable medium of claim 17, further comprising program code for:
providing access to the tracking information to each authorized recipient's email client so as to permit each authorized recipient's email client to share pieces of the file attachment.

19. The computer readable medium of claim 15, further comprising program code for:
controlling any further access to the file attachment by other recipients of the metadata file by controlling the addition of authorized recipients to the access control list.

20. The computer readable medium of claim 15, further comprising program code for:
presenting the metadata file in the form of a token or stub attached to the email.

21. The computer readable medium of claim 20, further comprising program code for:
configuring the token or stub to be selectable to initiate a request to access the file attachment via the peer-to-peer network.
